(19) United States
(12) Patent Application Publication
(10) Pub. No.: US 2005/0082786 A1
(43) Pub. Date: Apr. 21, 2005

(54) Reversible foot pedal for an exercise apparatus and method therefor

(75) Inventors: Michael R. Clark, Wadsworth, OH (US); Detlev F. Smith, Fairlawn, OH (US)

Correspondence Address: BROUSE MCDOWELL, 388 SOUTH MAIN STREET, SUITE 500, AKRON, OH, 44311-4407, US

(73) Assignee: Fitness Quest Inc.

(21) Appl. No.: 10/750,433

(22) Filed: Dec. 30, 2003

Related U.S. Application Data
(63) Continuation-in-part of application No. 29/188,307, filed on Aug. 15, 2003.

(51) Int. Cl. B62B 1/00; B60R 1/00; B60G 1/00; B62D 1/00

(52) U.S. Cl. 280/294; 280/29

(57) ABSTRACT

A reversible pedal body has first and second surfaces, wherein the first surface is adapted to contact an associated foot and the second surface is adapted to contact an associated shoe. The reversible pedal body may be a single part. Further, the pedal body has a front oppositely disposed from a rear. First and second lateral edges extend between the front and the rear. The pedal body has a hole extending between the first and second lateral edges adapted to receive an associated pedal lever. Weights are operatively connected to the pedal body such that one of the surfaces faces substantially upwards when an operator's foot is removed. Further, securing means may be attached to the pedal body which can rotate 360 degrees around the pedal body so that the securing means need not be removed when the operator chooses to utilize a different surface of the foot pedal.

This continuation-in-part patent application claims priority from a design patent filed on Aug. 15, 2003, having Ser. No. 29/188,307.

### I. BACKGROUND OF THE INVENTION

A. Field of the Invention

This invention pertains to a reversible foot pedal and a method therefore. More specifically, the present invention relates to a reversible foot pedal for exercise equipment such that a first surface is adapted to contact a rider's bare foot and a second surface is adapted to contact a rider's shoe.

B. Background of the Art

Bicycling is, and has been, one of the most common forms of exercise. Due to its obvious health benefits and popularity, stationary bicycles have become one of the most common pieces of exercise equipment, both in commercial and private gyms. Many individuals have chosen to have a stationary bicycle in their home, apartment or office. Because these individuals take advantage of having this exercise equipment at such a convenience location, many individuals find it desirable to use their stationary bicycle without shoes, i.e. in bare feet or with only socks.

The problem encountered with riding a stationary bicycle with only socks or bare feet is the comfort of the foot pedals. Because most foot pedals have tread to aid in the engagement of a rider's shoe, the foot pedal is uncomfortable to the bare foot rider. This is especially true with some modem bicycles, which may have pedal designs with serrated metal edges. In order to solve this problem, it has been known to position a pad cover in conjunction with the foot pedal in order to provide a flat surface. While these devices are suited for their intended purpose, there are still several shortfalls. First, it is difficult or overly cumbersome to attach such devices. Further, if the pedal over rotates when the rider removes his or her foot, the rider may reposition his or her foot on a portion that does not have the pedal cover, resulting in discomfort. In the event the pedal cover encloses the entire foot pedal, then the rider is faced with the inconvenience of having to remove the pad cover so that shoes may be worn.

Based upon the foregoing, there is a need in the art to provide a reversible foot pedal for exercise devices, which is a single part, but is configured to have a first surface to contact a rider's bare foot and a second surface to contact a rider's shoe.

### II. SUMMARY OF THE INVENTION

A new and improved apparatus comprises a reversible pedal body having first and second surfaces, wherein the first surface is adapted to contact an associated foot and the second surface is adapted to contact an associated shoe. The reversible pedal body is a single part. Further, the pedal body has a front oppositely disposed from a rear. First and second lateral edges extend between the front and the rear. The pedal body has a hole extending between the first and second lateral edges adapted to receive an associated pedal lever.

Another object of the present invention is to provide an apparatus wherein the first surface of the pedal body is curved.

Yet, another object of the present invention is to provide an apparatus wherein the curved first surface comprises a concave portion transitioning to a convex portion so as to conform to the arch of a rider's foot.

Further, another object of the present invention is to provide an apparatus wherein the pedal body further comprises a front edge substantially flush with the front of the pedal body and a rear edge substantially flush with the rear of the pedal body.

Still yet, another object of the present invention is to provide an apparatus wherein the front edge is left or right directional.

Another object of the present invention is to provide an apparatus wherein the second surface comprises tread adapted to provide friction engagement with the shoe.

Yet, another object of the present invention is to provide an apparatus wherein the second surface of the pedal body further comprises a front edge recessed from the rear of the pedal body and a rear edge recessed from the front of the pedal body.

Further, another object of the present invention is to provide an apparatus wherein the first and second surfaces have a front edge, wherein each of the front edges is directional.

Another object of the present invention is to provide a pedal body having at least one weight operatively connected to the pedal body such that one of the surfaces faces substantially upwards as the pedal body approaches an equilibrium position.

Still, another object of the present invention is to provide a pedal body having securing means operatively connected to the pedal body, wherein the securing means is adapted to rotate substantially 360 degrees around the pedal body.

Another object of the present invention is to provide a pedal body having a horizontal plane between the first and second surfaces and a weight having a central axis operatively connected to the pedal body, wherein the central axis is displaced relative to the horizontal body.

Further yet, another object of the present invention is to provide a foot pedal wherein the securing means is adapted to rotate at least 360 degrees about the pedal body.

Another object of the present invention is to provide a foot pedal wherein the securing means is adapted to rotate at least 180 degrees about the pedal body.

Still yet, another object of the present invention is to provide a method for using a foot pedal with an exercise device, the method comprising the steps of:
providing a pedal body having a first surface and a second surface oppositely disposed from the first surface; and securing means operatively connected to the pedal body;
positioning an associated foot on said first surface;
removing the foot from said first surface;
rotating said securing means about said pedal body; and,
repositioning the foot to said second surface.

Further, another object of the present invention is to provide a reversible foot pedal that is economical and cost effective to manufacture and purchase.

Still yet, another object of the present invention is to provide a reversible foot pedal that is easy to use.

These and additional object and advantages of the present invention will be more readily understood after a consideration of the drawings and the detailed description of the preferred embodiment.

### III BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a top perspective view showing the new design.

FIG. 2 is a top plan view of FIG. 1.

FIG. 3 is a side elevational view taken along line 3-3 of FIG. 1.

FIG. 4 is a front elevational view of FIG. 1.

FIG. 5 is a side elevational view taken along line 5-5 of FIG. 1.

FIG. 6 is a rear elevational view of FIG. 1.

FIG. 7 is a bottom plan view of FIG. 1.

FIG. 8 is a bottom perspective view of FIG. 1.

FIG. 9 is a top plan view of a strap that may be used with the present invention.

FIG. 10 is a perspective view of a rider using the reversible foot pedal a bare foot.

FIG. 11 is a perspective view of a rider using the reversible foot pedal wearing a shoe.

FIG. 12 is a perspective view of a second embodiment of the present invention.

FIG. 13 is a top plan view of FIG. 12.

FIG. 14 is a left side view of FIG. 12.

FIG. 15 is a front elevational view of FIG. 12.

FIG. 16 is a bottom plan view of FIG. 12.

FIG. 17 is another top plan view of FIG. 12.

FIG. 18 is a cross-sectional view of FIG. 17 taken along line 18-18.

FIG. 19 is a cross-sectional view of FIG. 17 taken along line 19-19.

FIG. 20 is a cross-sectional view of FIG. 17 taken along line 20-20.

### IV. DETAILED DESCRIPTION OF THE INVENTION

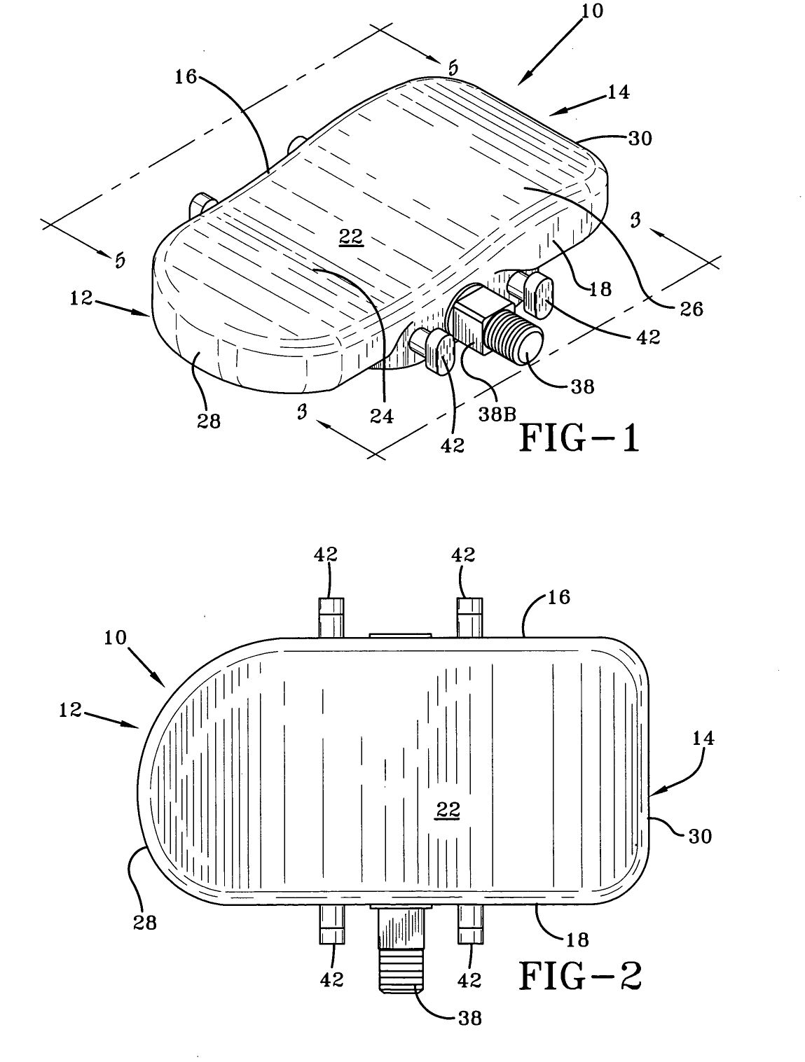

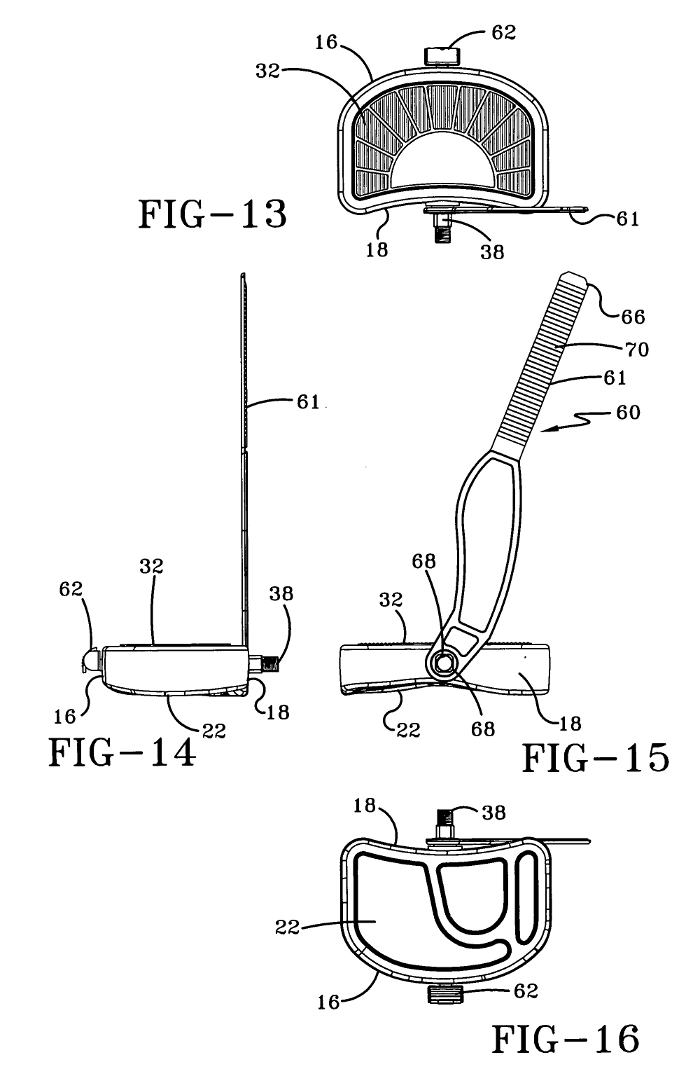

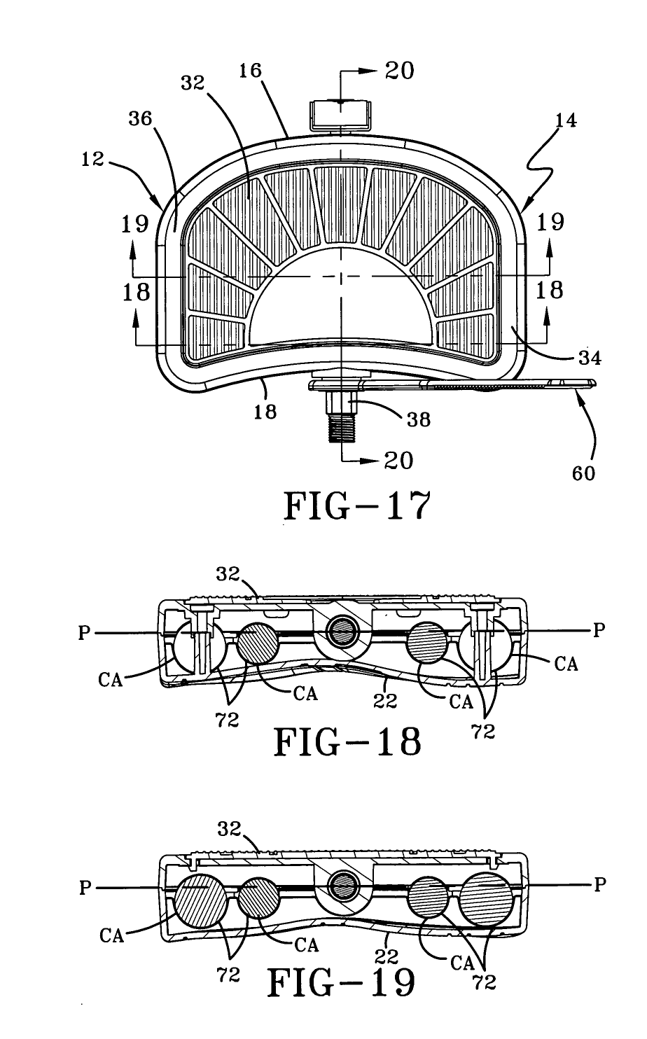

Referring now to the drawings wherein the showings are for purposes of illustrating a preferred embodiment of the invention only and not for purposes of limiting the same, FIG. 1-20 show the present invention.

With reference to FIGS. 1-20, an apparatus comprises a reversible pedal body 10 having a front 12 oppositely disposed from a rear 14. First and second lateral edges 16, 18 extend between the front 12 and rear 14. The pedal body 10 further comprises a first surface 22 and a second surface 32, which as shown in the FIGURES are 180 degrees disposed from each other.

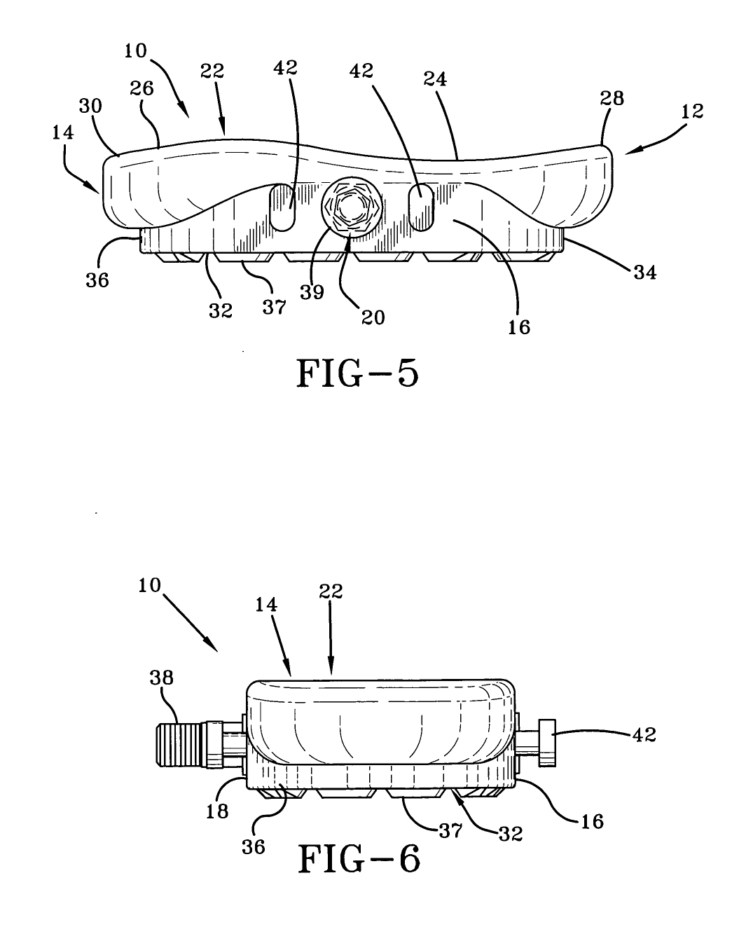

The pedal body 10 may be operatively connected to an associated exercise device through any manner chosen in accordance with sound engineering judgment. As shown in the FIGURES, a hole 20 extends between the first and second lateral edges 16, 18 to operatively connect to an associated pedal lever 54. In one embodiment, bearings (not shown) may be utilized on either end of the hole 20 to receive a shaft 38. The shaft 38 comprises two ends. The first end may be threaded to receive a fastener 38A, such as a nut, but not limited thereto, to secure the shaft in the hole 20, best seen in FIG. 5. The first end of the shaft 38 may extend past the first lateral edge, but this is not required. A removable cap 39, as shown in FIG. 5, may be utilized to cover the hole 20 on the first lateral edge 16 so as to prevent dirt or other debris from accumulating in the hole 20. The second end of the shaft 38 may also be threaded. As shown in FIG. 1, a flattened portion 38B is operatively connected to the threaded section. This provides for increased gripping capability so that the fastener on the first end can be loosened to ultimately remove the shaft from the hole 20. This configuration enables the pedal body 10 to easily rotate about the shaft 38. Since the pedal body 10 rotates with the rider's foot, the rider's foot is permitted to more easily flex and extend during cyclic movement, which would not be as comfortable with a rigidly attached pedal body.

With continuing reference to FIGS. 1-6, the first surface 22 is adapted to contact an associated rider's foot 56. When the first surface 22 faces upwards, the rider may ride an exercise device (not shown) in bare feet or simply with socks. The second surface 32 is adapted to contact an associated rider's shoe 58. When the second surface 32 faces upwards, the rider should wear an appropriate shoe while riding the exercise device. As shown in the FIGURES, the reversible pedal body 10 is a single part. What is meant by the term “single part” is that during the manufacturing, construction and/or assembly, multiple pieces may be, although not required, formed together such that they are permanently affixed before being utilized on the exercise device.

With reference to FIG. 1, the first surface 12 is contoured or curved. More specifically, the first surface 12 comprises a concave portion 24, which transitions into a convex portion 26 from the front 12 to the rear 14. This profile is adapted to conform to the arch of the rider's foot 56. With continuing reference to FIGS. 4 and 6, the first surface 22 further comprises a front edge 28 and a rear edge 30. The front and rear edges 28, 30 may be substantially flush with the front 12 and rear 14 of the reversible pedal body 10, although this is not required. It also contemplated to be within the scope of the present invention that the front and rear edges 28, 30 extend past the front 12 or rear 14 of the reversible pedal body 10. Further, the front edge 28 of the first surface 22 may be left or right directional.

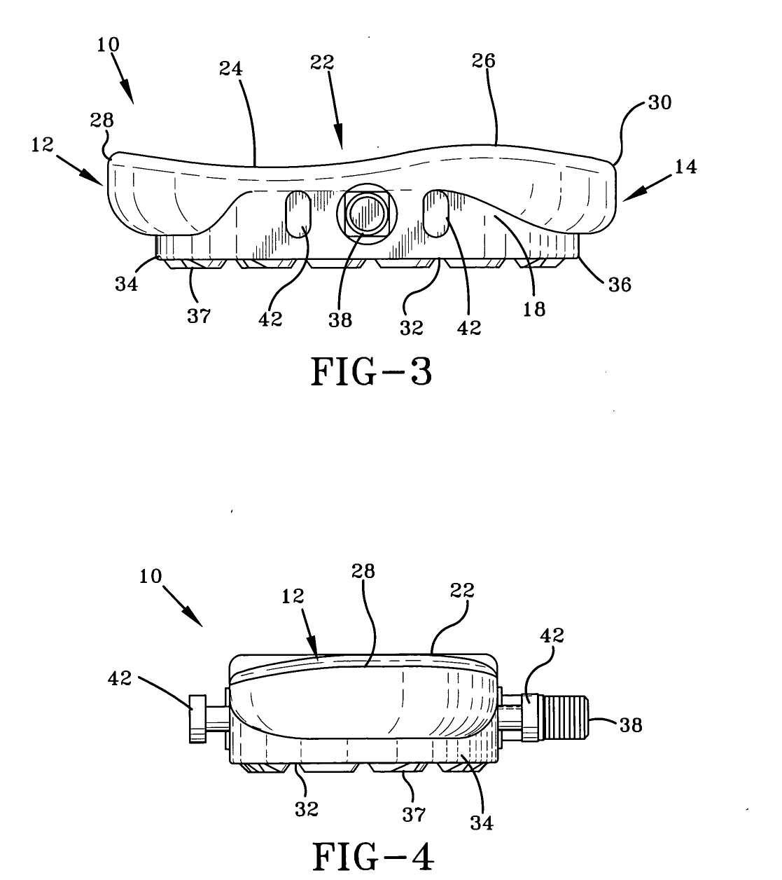

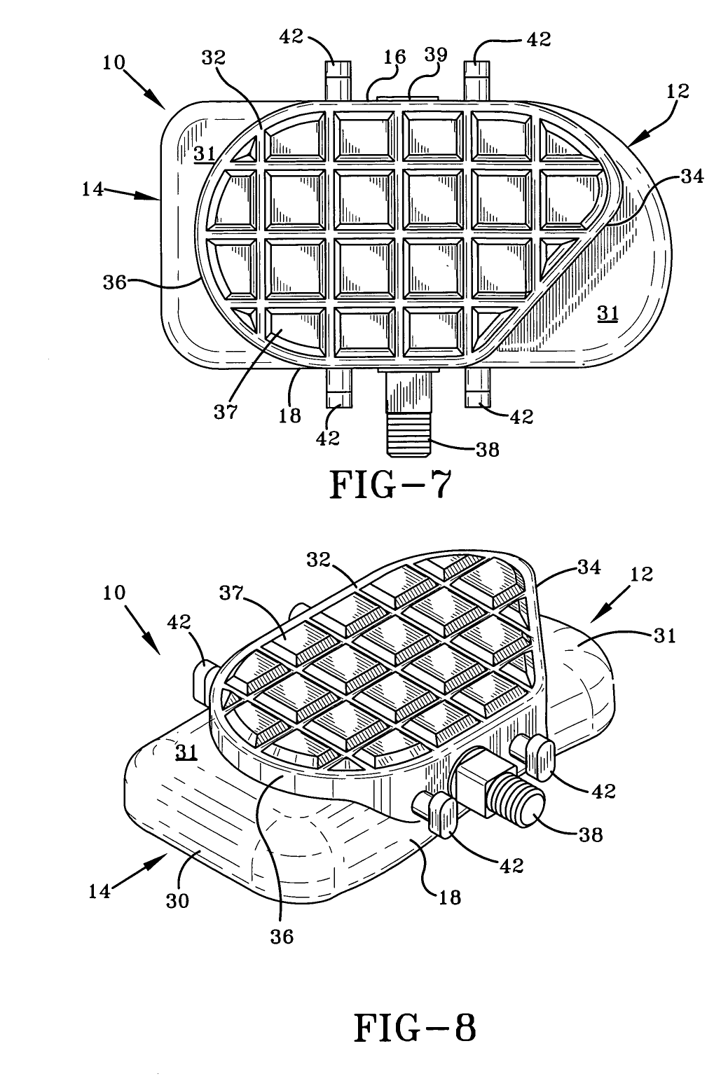

With reference now to FIGS. 3-8, the second surface 32 further comprises a rear edge 34 and a front edge 36. The rear edge 34 may be recessed from the front 12 of the pedal body, but the rear edge 34 may be flush with the front 12, or extend past the front 12 of the pedal body. Because the rear edge 34 may be angularly recessed from the front of the pedal body 10, which leaves a bottom portion 31 of the first surface 22 is exposed. The front edge 36 may also be recessed from the rear 14 of the pedal body 10. As shown in FIGS. 7 and 8, the front edge 36 may be arcuate or semi-circular in shape, although this is not required. Because of the recessed nature of the front edge 36, the bottom portion 31 of the first surface 22 is again exposed. As a result of the recessed rear and front edges 34, 36, the second surface 32 has the appearance of a raised platform. This provides many advantages, such as economical savings since less material is used in forming the pedal body 10. Further, the pedal body 10 has a more defined surface for placement of the rider's shoe 58. The second surface 32 of the pedal body 10 may also comprise tread 37. The tread 37 provides for increased frictional engagement of the rider's shoe 58 with respect to the second surface 37.

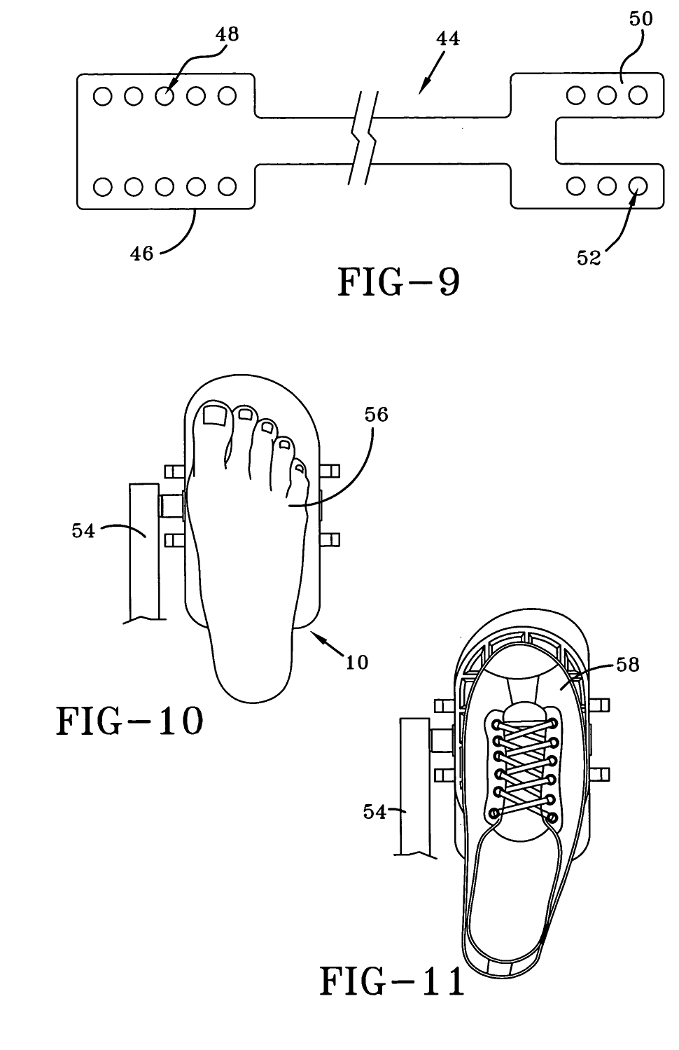

With reference to FIG. 9, securing means such as a strap 44 may be operatively connected to the pedal body 10 to further secure the rider's foot to the pedal body 10. As shown in the FIGURES, projections 42 extend from the lateral edges 16, 18 of the pedal body 10. Although not required, the projections 42 extend in a substantially perpendicular fashion from the lateral edges 16, 18. The strap 44 comprises a first end 46 and a second end 50. The first end 46 may be rectangular in shape and has a plurality of holes 52 defined therein to receive the projections 42 located on the first lateral edge 16. The second end 50 may be generally U-shaped and also has a plurality of holes 52 defined therein to receive the projections 42 located on the second lateral edge 18 of the pedal body. The U-shaped second end 50 enables the strap 44 to be secured to the pedal body 10 without interference from the fastener 38.

As previously stated, the pedal body 10 may be a single part. Generally, the pedal body may be fabricated from a durable, hard plastic material, but is not limited thereto. Any material chosen with sound engineering judgment may be utilized.

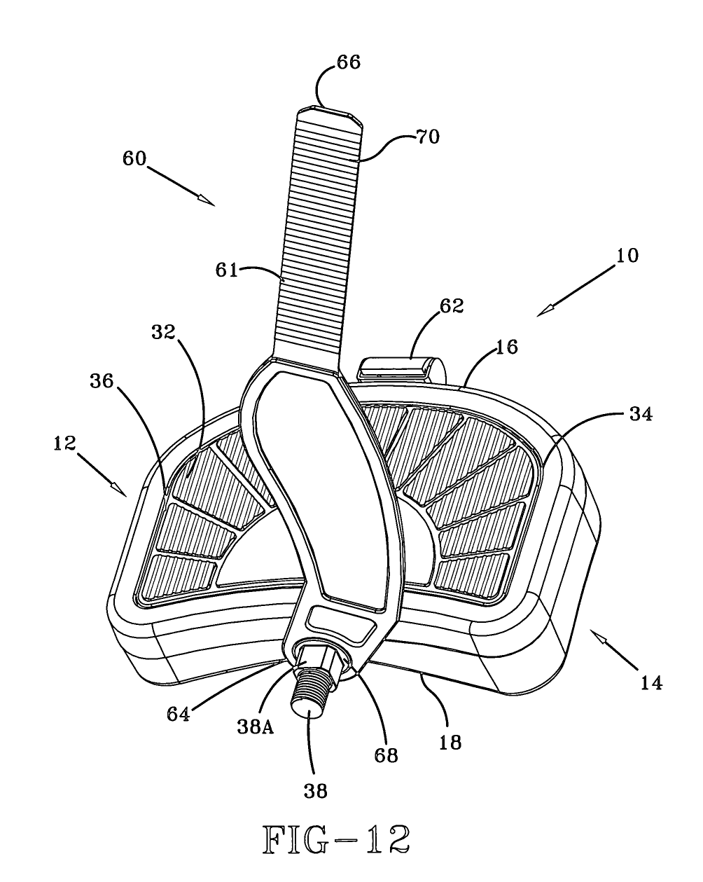

With reference to FIGS. 12-20, another embodiment of the present invention is shown. The reversible pedal body 10 may be constructed of multiple pieces joined together. With specific reference to FIGS. 18 and 19, weights 72 may be operatively connected to the pedal body 10. More specifically, the pedal body 10 has a horizontal plane P defined between the first surface 22 and the second surface 32. The weights 72 have a central axis CA. The weights 72 are positioned such that the central axis CA is displaced from the horizontal plane P. With this configuration, when an operator's foot is removed from the pedal body 10, the pedal body 10 will generally have one of its surfaces facing substantially upwards as the pedal reaches an equilibrium position. As shown in the FIGURES, the second surface 32, which has the tread 37, faces substantially upward after an operator's foot is removed. With continuing reference to FIGS. 18 and 19, the outer most weights 19 are shorter in length than the inner weights, but are wider in diameter. Of course, any weight configuration and size may be utilized that is chosen in accordance with sound engineering judgment.

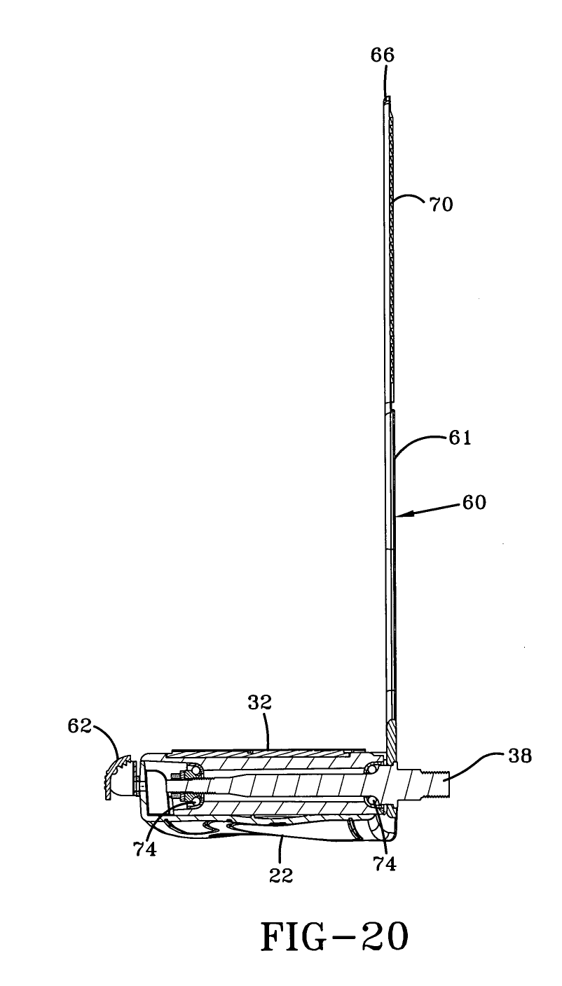

With reference now to FIGS. 12-20, securing means 60 is shown. The securing means 60 is unique in that it is adapted to rotate about the shaft 38 360 degrees without being removed from the pedal body 10. The securing means 60 comprises an attachment mechanism 62 secured to the first lateral edge 16 of the pedal body 10 through a rivet or screw. The securing means 60 also comprises a strap 61 having a first end 64 and a second end 66. The first end 64 has an opening 68 defined therein which is in rotatable engagement with the shaft 38. This is accomplished through attachment to a plastic housing of the lateral side 16. The second end 66 of the strap 61 comprises a plurality of ridges 70 which is able to engage the attachment mechanism 62. The pedal body 10 is rotatable about the shaft 38 through bearings 74, best seen in FIG. 20. As such, when an operator decides to switch the side of the pedal being utilized, the securing means 60 does not need to be disconnected from the pedal body 10. It is simply rotated about the shaft via the bearings 74 360 degrees and the operator can re-engage their foot with ease. The securing means 60 not only secures the foot on the pedal body 10, but it also provides for a “push-pull” feel on the foot during cyclic movement.

In order to use the exercise device (not shown) the following steps are followed. First, a reversible foot pedal 10 as herein described is provided. The pedal is rotatably secured to the pedal lever of the exercise device such that the second surface 32 is facing substantially upwards. Next, the rider's shoe is positioned on the second surface of the pedal so as to begin cyclic movement, as shown in FIG. 11. In the event the rider would choose to use the exercise apparatus with bare feet, the following steps should be taken. The rider removes his shoe from the second surface 32. The pedal body 10 is rotated substantially 180 degrees about shaft 38. The securing means 62 is also rotated 180 degrees, either in a clock-wise or counter clock-wise direction. At this point, the rider's bare foot can be positioned on the first surface 22 of the pedal body 10 to begin cycle movement, best seen in FIG. 10.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. An apparatus, comprising:
a reversible pedal body having first and second surfaces, wherein said first surface is adapted to contact an associated foot, said second surface is adapted to contact an associated shoe, said reversible pedal body being a single part, said pedal body having a front oppositely disposed from a rear, said pedal body having first and second lateral edges extending between said front and said rear, said pedal body being operatively connected to an associated exercise device.

2. The apparatus of claim 1, wherein said first surface is curved.

3. The apparatus of claim 1, wherein said first surface further comprises a concave portion and a convex portion so as to substantially conform to the arch of the foot.

4. The apparatus of claim 1, wherein said first surface further comprises:
a front edge substantially flush with said rear of said pedal body; and
a rear edge substantially flush with said front of said pedal body.

5. The apparatus of claim 4, wherein said front edge is left or right directional.

6. The apparatus of claim 1, wherein said second surface further comprises:
a front edge, wherein at least a portion of said front edge is recessed from said rear of said pedal body; and
a rear edge, wherein at least a portion is recessed from said front of said pedal body.

7. The apparatus of claim 6, wherein said front edge is right or left directional.

8. The apparatus of claim 1, wherein said second surface comprises tread.

9. The apparatus of claim 1, further comprising securing means operatively connected to said pedal body, wherein said securing means is adapted to rotate substantially 360 degrees around said pedal body.

10. The apparatus of claim 1, further comprising securing means operatively connected to said pedal body, wherein said securing means is adapted to rotate substantially 180 degrees around said pedal body.

11. The apparatus of claim 1, further comprising at least one weight operatively connected to said pedal body, such that one of said surfaces faces substantially upwards as said pedal body approaches an equilibrium position.

12. A foot pedal for an exercise device, comprising:
a reversible pedal body having first and second surfaces, wherein said first surface is adapted to contact an associated foot, said first surface being curvilinear, said second surface is adapted to contact an associated shoe, said pedal body having a front oppositely disposed from a rear, said pedal body having first and second lateral edges extending between said front and said rear, said pedal body being operatively connected to an associated exercise device.

13. The foot pedal of claim 12, wherein said first surface further comprises a rear edge, said first surface having a concave portion transitioning into a convex portion.

14. The foot pedal of claim 12, further comprising at least one weight operatively connected to said pedal body.

15. The foot pedal of claim 12, wherein said foot pedal comprises a plurality of weights operatively connected to said pedal body such that one of the surfaces faces substantially upwards as it reaches an equilibrium position.

16. The foot pedal of claim 12, further comprising securing means operatively connected to said pedal body, wherein said securing means is adapted to rotate 360 degrees about said pedal body.

17. The foot pedal of claim 12, wherein said second surface further comprises tread, said tread adapted to provide friction engagement with the shoe.

18. A reversible foot pedal, comprising:
a pedal body having a first surface and a second surface oppositely disposed from said first surface; and,
securing means operatively connected to said pedal body, said securing means adapted to limit movement of an associated foot relative to said pedal body, wherein said securing means is adapted to rotate about said pedal body such that an operator can position an associated foot on either said first surface or said second surface to utilize said securing means without removing said securing means from said pedal body.

19. The reversible foot pedal of claim 18, further comprising:
a horizontal plane between said first surface and said second surface; and
at least one weight having a central axis, wherein said central axis is displaced from said horizontal plane.

20. The reversible foot pedal of claim 18, wherein said first surface is adapted to contact an associated foot and said second surface is adapted to contact an associated shoe.

21. A method for using a foot pedal with an exercise device, the method comprising the steps of:
providing a pedal body having a first surface and a second surface oppositely disposed from said first surface; and securing means operatively connected to said pedal body;
positioning an associated foot on said first surface;
removing the foot from said first surface;
rotating said securing means about said pedal body; and,
repositioning the foot to said second surface.

22. The method of claim 21, wherein said pedal body further comprises a horizontal plane between said first surface and said second surface, the method further comprising the step of:
providing a weight having a central axis, said weight operatively connected to said central axis;
positioning said weight such that said central axis is displaced from said horizontal plane.
